(19) United States
(12) Patent Application Publication
(10) Pub. No.: US 2005/0176894 A1
(43) Pub. Date: Aug. 11, 2005

(54) Method of emulsion polymerization using liquid miniemulsion as seed particle

(76) Inventors: Yang-seung Jeong, Incheon (KR); Kyung-woo Lee, Daejeon (KR); Hyun-chul Ha, Gyeonggi-do (KR)

Correspondence Address: MCKENNA LONG & ALDRIDGE LLP, 1900 K STREET, NW, WASHINGTON, DC, 20006, US

(21) Appl. No.: 11/049,941

(22) Filed: Feb. 4, 2005

(30) Foreign Application Priority Data
Feb. 5, 2004 (KR) 10-2004-0007573

(51) Int. Cl. C08F 265/02

(52) U.S. Cl. 525/301

(57) ABSTRACT

The present invention relates to a method of the seed(ed) emulsion polymerization using a submicron-sized liquid particle as seed, more particularly to a method of the seed(ed) emulsion polymerization comprising the steps of (1) preparing a stable miniemuslion via homogenizing the following ingredients—at least one liquid material, an emulsifier, a hydrophobe, deionized water and, optionally, an initiator; and (2) adding at least one monomer and, optionally, an emulsifier and deionized water, and/or an initiator, at once, batchwise or continuously, to the prepared miniemulsion seed and polymerizing them. Also, it is possible to contain the liquid material inside the resultant latex.

### TECHNICAL FIELD

The present invention relates to a method of seed(ed) emulsion polymerization using a submicron-sized liquid particle as seed, more particularly to a method of seed(ed) emulsion polymerization comprising the steps of (1) preparing a stable miniemuslion via homogenizing the following ingredients—at least one liquid material, an emulsifier, a hydrophobe, deionized water and, optionally, an initiator; and (2) adding at least one monomer and, optionally, an emulsifier and deionized water, and/or an initiator, at once, batchwise or continuously, to the prepared miniemulsion seed and polymerizing them.

Utilizing the method of the present invention, it is possible to use a variety of liquid materials, which have not been utilized in the conventional emulsion polymerization, as seed particle. Because the liquid seed particle remains stable during polymerization, stable polymer growth can be attained with the present invention. The latex particle resultant from the polymerization was identified to include the liquid material as seed.

### BACKGROUND ART

Seed(ed) emulsion polymerization is a widely used industrial latex production method in order to (1) prepare a latex having a uniform size and its uniform distribution with the particle formation process removed or (2) combine different polymers, by inducing a newly polymerized polymer to grow in the latex particle. The method is utilized to prepare PVC paste resins, ABS resins, impact modifiers, processing aids and other latex-based products. Recently, researches on preparing an inorganic-organic composite particle by modified an inorganic particle chemically or physically and then performing seed(ed) emulsion polymerization using the particle as seed were prospered.

Formerly, liquid, which is insoluble to water, particle was never used as seed in seed(ed) emulsion polymerization. It is because the liquid material which is emulsified by the general method is not able to maintain the identity (size stability) as seed during emulsion polymerization. If the materials composed of the pre-emulsified liquid particle are mixed with monomers homogeneously, all of them become mixed and lost their identity as seed during polymerization because of thermodynamic equilibrium. Then this system changes as the conventional emulsion polymerization by the liquid materials as kinds of solvents. Resultantly, provided are newly formed latex particles which are the swelled or phase separated particles according to the miscibility between the liquid and the polymer. But if the liquid materials are immiscible with monomers, there are two kinds of emulsified droplets in the polymerization system. Thereafter, the polymerization proceeds with the monomers like traditional emulsion polymerization while the liquid materials are transformed as bulk phase. Resultantly, a composition in which a bulk liquid is separated from a polymer latex is obtained.

Accordingly, it was impossible to use a liquid particle as seed in the conventional seed(ed) emulsion polymerization.

The present inventors tried in various ways to develop a method of seed(ed) emulsion polymerization using a liquid particle seed. In doing so, the present inventors found that miniemulsified liquid particles are able to conserve their identity and served as seed during the seed(ed) emulsion polymerization like as the polymeric seed particles with the conventional seed(ed) emulsion polymerization method. Also, the present inventors found that a third party chemicals was encapsulated in the composite particle latex, which cannot be prepared by the conventional method, can be prepared if the liquid material to be utilized in the miniemulsified seed particle is miscible with third party materials.

In general, miniemulsion refers to stable emulsion of spherical liquid materials of which diameter is in the range of 50-800 nm dispersed in a continuous phase (normally, water) with the aid of an emulsifier and a hydrophobe. If liquid materials are dispersed in a continuous phase as small particles, the liquid material diffuses from the smaller particles to the larger particles based on Kelvin pressure difference due to the curvature effect, so that resultantly the liquid material becomes separated from the continuous phase. This phenomena is so-called Ostwald ripening. However, if a hydrophobic material (so-called hydrophobe, the solubility to water is 5×10⁻⁶ g/Kg) is dissolved in the liquid material and miniemulsified, the concentration difference of the hydrophobe between the smaller and larger particles based on the Ostwald ripening is triggered the Osmotic Pressure between those particles. Finally these two forces are balanced and stable emulsion can be provided. This is the so-called miniemulsion.

The present inventors found that a liquid material can be used as seed particle utilizing the characteristic of the miniemulsion. Thus, the present inventors developed a new method of seed(ed) emulsion polymerization using a liquid miniemulsion as seed particle.

### DISCLOSURE OF INVENTION

The present invention relates to a method of seed(ed) emulsion polymerization using a submicron-sized liquid particle as seed, more particularly to a method of seed(ed) emulsion polymerization characterized by comprising the steps of (1) preparing a stable miniemuslion via homogenizing the following ingredients—at least one liquid material, an emulsifier, a hydrophobe, deionized water and, optionally, an initiator; and (2) adding at least one monomer and, optionally, an emulsifier and deionized water, and/or an initiator, at once, batchwise or continuously, to the prepared miniemulsion seed and polymerizing them.

Hereunder is given a detailed description of the present invention, but not limited on them.

The liquid material may be used alone or in a mixture of solid materials and/or liquid materials. Preferably, the material remains in the liquid state under a pressure of 1-20 atm and a temperature of 10-100° C. Also, preferably, the total solubility of the liquid material is at lower than 7.5 g per 100 g of water.

To take examples, the liquid material may be at least one selected from the group consisting of aliphatic and aromatic hydrocarbons, specifically C₄-C₂₀ hydrocarbons, such as hexane, heptane, cyclohexane, octane, nonane, decane, benzene, toluene, xylene, etc. and an isomer thereof, C₁₀-C₂₀ aliphatic and aromatic alcohols, C₅-C₂₀ aliphatic and aromatic esters, C₅-C₂₀ aliphatic and aromatic ethers, silicone compounds, C₅-C₂₀ fatty acid derivatives, natural and synthetic oils, pharmaceutical materials and controlled release materials, which are in liquid or solid, but not limited to these.

In the first step, the proportion of the liquid material to water is preferably 60:40 to 1:99 by volume.

Preferably, a solubility of the hydrophobe in water at 25° C. is at most 5×10⁻⁶ g/kg. It may be at least one selected from the group consisting of C₁₂-C₂₀ aliphatic and aromatic hydrocarbon derivatives, C₁₂-C₂₀ aliphatic alcohols, acrylate having C₁₂-C₂₀ alkyl groups, C₁₂-C₂₀ alkyl mercaptans and a mixture thereof, organic dyes, fluorinated alkanes, silicone oil compounds, natural and synthetic oils, and oligomers and polymers having a molecular weight of 1,000-500,000. More specifically, the hydrophobe may be an alkane or an alcohol having at least 12 carbon atoms, including such isomer as hexadecane, heptadecane, octadecane, cetyl alcohol, etc., isopropyl laurate, isopropyl palmitate, hexyl laurate, isopropyl myristate, myristyl myristate, cetyl myristate, 2-octyldecyl myristate, isopropyl palmitate, 2-ethylhexyl palmitate, butyl stearate, decyl oleate, 2-octyldodecyl oleate, glycol ester oil, such as polypropylene glycol monooleate and neopentyl glycol 2-ethylhexanoate, polyalcohol ester oil, isostearate, triglyceride, coco fatty acid triglyceride, almond oil, apricot oil, avocado oil, theobroma oil, carrot seed oil, caster oil, tangerine seed oil, coconut oil, corn oil, cotton seed oil, cucumber oil, egg oil, jojoba oil, lanolin oil, flaxseed oil, mineral oil, mink oil, olive oil, palm oil, kernel oil, peach kernel oil, peanut oil, oil seed rape, safflower oil, sesame oil, shark liver oil, soybean oil, sunflower seed oil, sweet almond oil, beef tallow, mutton tallow, turtle oil, plant oil, whale oil, wheat germ oil, organic silicones, siloxanes, alkyl mercaptans, n-dodecyl mercaptan and t-dodecyl mercaptan, fluorinated alkanes such as hexafluorobenzene and a mixture thereof, but is not limited to them.

The hydrophobe may be used in at least 0.5 part by weight, more preferably in at least 2 parts by weight, and most preferably in at least 3 parts by weight, per 100 parts by weight of the liquid material.

The emulsifier may be at least one selected from the group consisting of an anionic emulsifier, a cationic emulsifier and a non-ionic emulsifier. It may be used in 0.01-15.0 parts by weight per 100 parts by weight of the liquid material.

In the resultant liquid particle miniemulsion, the liquid particle, which is dispersed in water, has a diameter ranging from 50 nm to 1500 nm. The diameter does not increase by 20% or more when the miniemulsion is kept at room temperature for a day.

The initiator is a free radical generating chemicals and its water solubility is lower than 0.5 g per 1 kg water. The initiator is at least one selected from the group consisting of peroxides, azo compounds and a mixture thereof with a compound inducing oxidation-reduction thereof. The initiator may be used in 0.1-3 parts by weight per 100 parts by weight of the liquid material.

For the compound inducing oxidation-reduction reactions of the initiator, those commonly known in the related field may be used.

The miniemulsion of the liquid mixture is made by high shear homogenization through strong shear force transferred to the medium. The homogenization is performed with any apparatus commonly used in the related field. For example, a microfluidizer, an ultrasonifier, a Manton-Gaulin homogenizer, an Omni-mixer, and a Spuraton pump etc. are used for commercially, but not limited them.

At least one monomer is added to the resultant liquid seed particle miniemulsion to perform polymerization. The amount of the monomer is determined so as to be 0.01:0.99 to 0.9:0.1 by weight of the proportion of the liquid material to the monomer.

The monomer is able to be polymerized by free radical generating initiators. It may be at least one free-radically polymerizable monomer selected from the group consisting of methacrylate derivatives, acrylate derivatives, acrylic acid derivatives, methacrylonitrile, ethylene, butadiene, isoprene, styrene, styrene derivatives, acrylonitrile derivatives, vinyl ester derivatives and halogenated vinyl derivatives. More specifically, the monomer may be at least one selected from the group consisting of styrene, α-methylstyrene, p-methyl styrene, p-nitrostyrene, ethylvinylbenzene, vinylnaphthalene, methyl methacrylate, ethyl acrylate, hydroxyethyl methacrylate, n-butyl methacrylate, isobutyl acrylate, isobutyl methacrylate, n-hexyl acrylate, n-hexyl methacrylate, ethylhexyl acrylate, ethylhexyl methacrylate, n-octyl acrylate, n-octyl methacrylate, decyl acrylate, decyl methacrylate, dodecyl acrylate, dodecyl methacrylate, stearyl acrylate, stearyl methacrylate, cyclohexyl acrylate, cyclohexyl methacrylate, 4-tert-butylcyclohexyl methacrylate, benzyl acrylate, benzyl methacrylate, phenylethyl acrylate, phenylethyl methacrylate, phenylpropyl acrylate, phenylpropyl methacrylate, phenylnonyl acrylate, phenylnonyl methacrylate, 3-methoxybutyl acrylate, 3-methoxybutyl methacrylate, butoxyethyl acrylate, butoxyethyl methacrylate, diethylene glycol monoacrylate, diethylene glycol monomethacrylate, triethylene glycol monoacrylate, triethylene glycol monomethacrylate, tetraethylene glycol monoacrylate, tetraethylene glycol monomethacrylate, furfuryl acrylate, furfuryl methacrylate, tetrahydrofurfuryl acrylate, tetrahydrofurfuryl methacrylate, acrylonitrile, vinyl acetate, vinyl pivalate, vinyl propionate, vinyl 2-ethylhexanoate, vinyl neononanoate and vinyl neodecanoate, but not limited to them.

The monomer is added at once, batchwise or continuously (including the power feed type). As required, it may be mixed with an emulsifier and deionized water to form an emulsion and then added at once, batchwise or continuously (including the power feed type).

The additional emulsifier may be added to stabilize the latex particles but the amount of the emulsifier should not exceed its CMC (critical micelle concentration). The additional emulsifier, if needed, charged in the polymerization step may be identical to or different from the one used in the miniemulsion formation step.

If the monomer is charged as an emulsion, mixed with the deionized water and the emulsifier, the surface area of the monomer for diffusion increases, thereby increasing the rate of its diffusion to the seed particle.

During the polymerization, an additional initiator may be added at once, batchwise or continuously. The initiator may be added along with at least one monomer or separately.

The additional initiator may be at least one selected from the free radical generating group consisting of peroxides, azo compounds and a mixture thereof with a compound inducing oxidation-reduction thereof. It is independent from the one used in the miniemulsion formation step.

In the present invention, the initiator should be charged during miniemulsion step and/or polymerization step.

The polymerization temperature and other condition of the polymerization step is the same as those of the generally known emulsion polymerization. In general, the polymerization temperature is 25-160° C., preferably 40-100° C. And, the polymerization time is 3-24 hours, preferably 4-10 hours.

A buffering chemical may be further added to keep the pH constant in the polymerization step.

The seed(ed) emulsion polymerization in which a liquid miniemulsion is used as seed, as in the present invention, is advantageous because a uniform and stable miniemulsion can be included the various ingredients in the liquid seed. This kind of the liquid included composite particle latex cannot be obtained by other polymerization methods.

### BRIEF DESCRIPTION OF DRAWINGS

FIG. 1 is the transmission electron micrograph (TEM) of the polymer prepared in Example 1.

FIG. 2 is the transmission electron micrograph (TEM) of the polymer prepared in Example 2.

FIG. 3 is the photograph showing the polymer suspension prepared in Example 1, which has been layer-separated by centrifugation.

### BEST MODE FOR CARRYING OUT THE INVENTION

Hereinafter, the present invention is described further in detail through examples. However, the following examples are only for the understanding of the present invention and the present invention is not limited to or by them.

### EXAMPLE 1

A mixture of 100 parts by weight of hexane, 10 parts by weight of hexadecane, 0.5 part by weight of lauryl peroxide, 0.4 part by weight of sodium dodecylsulfosuccinate (Aerosol OT) and 300 parts by weight of deionized water was prepared into a seed particle miniemulsion using an ultrasonic homogenizer. A polymerization reactor was heated to 70° C. 12 parts by weight of methyl methacrylate was added at once to 100 parts by weight of the seed miniemulsion in the polymerization reactor purged with nitrogen. After 10 hours, reaction was stopped. The related data are shown in Table 1 and Table 2.

### EXAMPLE 2

A mixture of 100 parts by weight of silicone, 10 parts by weight of hexadecane, 0.5 part by weight of lauryl peroxide, 0.4 part by weight of sodium dodecylsulfosuccinate (Aerosol OT) and 300 parts by weight of deionized water was prepared into a seed particle miniemulsion using an ultrasonic homogenizer. A polymerization reactor was heated to 70° C. 24 parts by weight of methyl methacrylate was added batchwise to 100 parts by weight of the seed miniemulsion in the polymerization reactor for 5 hours using a pump purged with nitrogen. After 12 hours, reaction was stopped. The related data are shown in Table 1 and Table 2.

### EXAMPLE 3

A mixture of 100 parts by weight of octane, 10 parts by weight of hexadecane, 0.5 part by weight of lauryl peroxide, 0.3 part by weight of sodium dodecylsulfosuccinate (Aerosol OT) and 300 parts by weight of deionized water was prepared into a seed particle miniemulsion using an ultrasonic homogenizer. 20 parts by weight of methyl methacrylate, per 100 parts by weight of the miniemulsion, was put in a first feeder directly connected with a polymerization reactor. 20 parts by weight of styrene was put in a second feeder connected with the first feeder, so that the styrene can be transferred to the first feeder. The reactor was heated to 70° C. The two monomers were pumped into the polymerization reactor for 5 hours, purged with nitrogen. After 12 hours, reaction was stopped. The related data are shown in Table 1 and Table 2.

### EXAMPLE 4

A mixture of 100 parts by weight of dioctylphthalate, 10 parts by weight of hexadecane, 0.5 part by weight of lauryl peroxide, 0.4 part by weight of sodium dodecylsulfosuccinate (Aerosol OT) and 300 parts by weight of deionized water was prepared into a seed particle miniemulsion using an ultrasonic homogenizer. A polymerization reactor was heated to 70° C. 48 parts by weight of methyl methacrylate was added at once to 100 parts by weight of the miniemulsion in the polymerization reactor purged with nitrogen. After 10 hours, reaction was stopped. The related data are shown in Table 1 and Table 2.

### COMPARATIVE EXAMPLE 1

100 parts by weight of methyl methacrylate, 0.1 part by weight of lauryl peroxide, 0.1 part by weight of sodium dodecylsulfosuccinate (Aerosol OT) and 300 parts by weight of deionized water were put in a reactor. The mixture was heated for 10 hours while stirring at 80° C. at 150 rpm under nitrogen reflux to obtain a polymer seed. 20 parts by weight of styrene was added at once to 100 parts by weight of the resultant polymer seed particle latex. Polymerization was performed at 70° C. for 10 hours. The related data are shown in Table 1 and Table 2.

### COMPARATIVE EXAMPLE 2

100 parts by weight of methyl methacrylate, 0.1 part by weight of lauryl peroxide, 0.1 part by weight of sodium dodecylsulfosuccinate (Aerosol OT) and 300 parts by weight of deionized water were put in a reactor. The mixture was heated for 8 hours while stirring at 80° C. at 150 rpm under nitrogen reflux to obtain a polymer seed. 20 parts by weight of methyl methacrylate was batchwise added to 100 parts by weight of the resultant polymer seed particle latex for 5 hours. Polymerization was performed at 80° C. for 10 hours. The related data are shown in Table 1 and Table 2.

### COMPARATIVE EXAMPLE 3

For comparison with the common emulsion, a mixture of 100 parts by weight of hexane, 0.1 part by weight of lauryl peroxide, 0.4 part by weight of sodium dodecylsulfosuccinate (Aerosol OT) and 300 parts by weight of deionized water was treated with an ultrasonic homogenizer and observed. The resultant emulsion was separated into a hexane-containing organic layer and an aqueous layer within 3 minutes after stopping ultrasonic homogenization.

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| Liquid | Hexane | 100 | — | — | — | — | — | 100 |
| material | Silicone | — | 100 | — | — | — | — | — |
| | Octane | — | — | 100 | — | — | — | — |
| | Dioctyl | — | — | — | 100 | — | — | — |
| | phthalate | | | | | | | |

| | | | | | | | |
|---|---|---|---|---|---|---|---|
| Hexadecane | 10 | 10 | 10 | 10 | — | — | — |
| (hydrophobe) | | | | | | | |
| Lauryl peroxide | 0.5 | 0.5 | 0.5 | 0.5 | 0.1 | 0.1 | 0.1 |
| (initiator) | | | | | | | |
| Aerosol OT | 0.4 | 0.4 | 0.3 | 0.4 | 0.1 | 0.1 | 0.4 |
| (emulsifier) | | | | | | | |
| Deionized water | 300 | 300 | 300 | 300 | 300 | 300 | 300 |
| Methyl | — | — | — | — | 100 | 100 | — |
| methacrylate | | | | | | | |
| Seed particle | >30 | >30 | >30 | >30 min | 10 hr | 8 hr | — |
| preparation time | min | min | min | | | | |
| Seed particle | 530 | 454 | 526 | 469 | 321 | 298 | Immeasurable |
| size (nm) | | | | | | | |

TABLE 2

| | | | | | Comparative | Comparative |
|---|---|---|---|---|---|---|
| | Example 1 | Example 2 | Example 3 | Example 4 | Example 1 | Example 2 |
| Seed particle | 100 | 100 | 100 | 100 | 100 | 100 |
| miniemulsion/polymer | | | | | | |
| seed | | | | | | |
| Methyl methacrylate | 12 | 24 | 20 | 48 | — | 20 |
| Styrene | — | — | 20 | — | 20 | — |
| Addition method | At once | batchwise | Power | At once | At once | batchwise |
| | | | feed | | | |
| Conversion ratio (%) | 93.8 | 91.6 | 95.3 | 94.3 | 95.2 | 94.1 |
| Particle size of | 598 | 530 | 448 | 587 | 354 | 364 |
| final product (nm) | | | | | | |

As seen in Table 2, effective emulsion polymerization was possible in each of Examples, whether the monomers were added at once, batchwise or continuously by the power feed type. As the amount of added monomer increased, the particle size of the final latex increased. This means that polymerization of the monomer is performed inside the liquid material-containing seed particle.

Comparative Examples 1 and 2, which were performed according to the conventional polymer seed(ed) emulsion polymerization, showed a very long polymer seed preparation time of 8-10 hours. Comparative Example 3, in which the common emulsion was prepared without a hydrophobe, showed poor seed particle emulsion stability. That is, the emulsion was separated with organic and water phase in less than 3 minutes when it kept at room temperature, making it impossible to use the liquid material as seed particle.

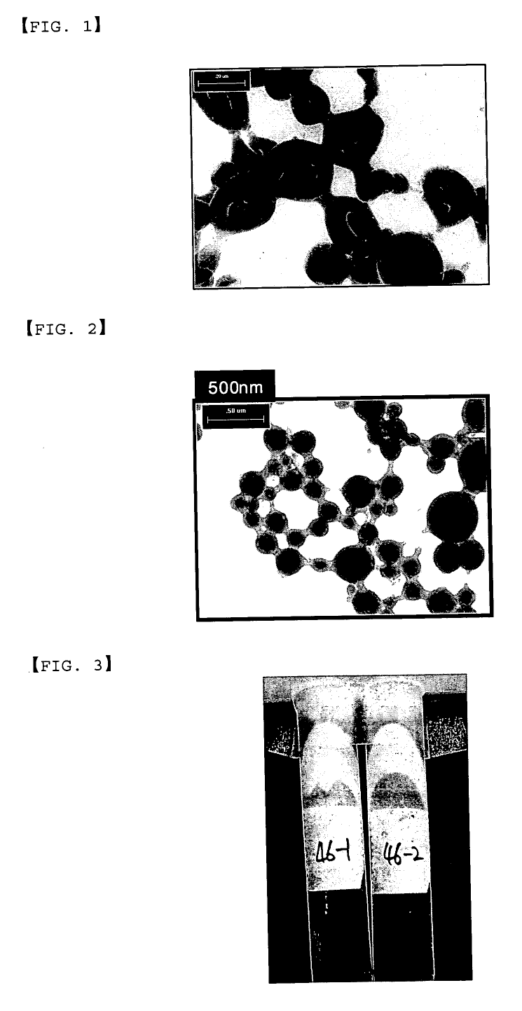

FIGS. 1 and 2 are the transmission electron micrographs of the final product. As seen in FIGS. 1 and 2, the liquid material and the polymer are present in the same particle. This means that polymerization occurred with the liquid material as seed particle.

Centrifugation

The latex obtained in Example 1 was centrifuged at 15,000 rpm for 1 hour. As seen in FIG. 3. Phase separation was observed. When the latex is centrifuged, the particle containing the liquid material goes upward because it has a smaller density than water. If polymerization is performed in water, the resultant polymer settles down. Because a polymer prepared by the common emulsion polymerization cannot contain a liquid material, the liquid material exists in the upper layer and the polymer particle exists in the lower layer after centrifugation. However, in the latex obtained in Example 1, most particles existed in the upper layer because both the liquid material and the polymer exist in the same particle. This also shows that the polymer was polymerized using the liquid material as seed particle.

### Industrial Applicability

As apparent from the above description, the method of emulsion polymerization according to the present invention is capable of using a variety of liquid materials, which could not be used formerly, as seed particle.

While the present invention has been described in detail with reference to the preferred embodiments, those skilled in the art will appreciate that various modifications and substitutions can be made thereto without departing from the spirit and scope of the present invention as set forth in the appended claims.

1. A method of seed(ed) emulsion polymerization using a submicron-sized liquid particle as seed.

2. The method of claim 1, wherein the submicron-sized liquid seed particle is a miniemulsion, prepared by homogenizing a mixture of at least one liquid material, an emulsifier, a hydrophobe, deionized water and, optionally, an initiator.

3. The method of claim 2, wherein at least one monomer and, optionally, an emulsifier and deionized water are added to the liquid miniemulsion for polymerization.

4. The method of claim 2, wherein the liquid material is used in per 100 parts by weight, the emulsifier is used in 0.01-15.0 parts by weight, the hydrophobe is used in at least 0.5 part by weight and the initiator is used in 0.1-3 parts by weight.

5. The method of claim 2, wherein the proportion of the liquid material to water ranges from 60:40 to 1:99 by volume.

6. The method of claim 1, wherein the liquid particle is prepared from a liquid material which remains in the liquid state at a temperature of 10-100° C. and a pressure of 1-20 atm.

7. The method of claim 2, wherein the liquid material remains in the liquid state at a temperature of 10-100° C. and a pressure of 1-20 atm.

8. The method of claim 1, wherein the liquid particle is prepared from a liquid material and the sum of the water solubility of the ingredients which composed of the liquid material at room temperature is lower than 7.5 g per 100 g of water.

9. The method of claim 2, wherein the sum of the water solubility of the ingredients which composed of the liquid material at room temperature is lower than 7.5 g per 100 g of water.

10. The method of claim 1, wherein the liquid particle is dispersed in water, has a diameter ranging from 50 nm to 1500 nm and the diameter does not increase by 20% or more when kept at room temperature for a day.

11. The method of claim 2, wherein the water solubility of the hydrophobe is lower than or equal to 5×10⁻⁶ g/kg at 25° C.

12. The method of claim 2, wherein the hydrophobe is at least one selected from the group consisting of C₁₂-C₂₀ aliphatic and aromatic hydrocarbon derivatives, C₁₂-C₂₀ aliphatic alcohols, acrylate having a C₁₂-C₂₀ alkyl groups, C₁₂-C₂₀ alkyl mercaptan derivatives, organic dyes, fluorinated alkanes, silicone oil compounds, natural and synthetic oils, and oligomers and polymers having a molecular weight of 1,000-500,000.

13. The method of claim 2, wherein the emulsifier is at least one selected from the group consisting of an anionic emulsifier, a cationic emulsifier and a non-ionic emulsifier.

14. The method of claim 3, wherein the monomer is at least one free-radically polymerizable monomer selected from the group consisting of methacrylate derivatives, acrylate derivatives, acrylic acid derivatives, methacrylonitrile, ethylene, butadiene, isoprene, styrene, styrene derivatives, acrylonitrile derivatives, vinyl ester derivatives and halogenated vinyl derivatives.

15. The method of claim 3, wherein the ratio of the liquid material, composed of the seed particle miniemulsion and the monomer ranges from 0.01:0.99 to 0.9:0.1 by weight.

16. The method of claim 3, wherein the mixture of the monomer and, optionally, the emulsifier and the deionized water is added at once, batchwise or continuously in the polymerization step.

17. The method of claim 16, wherein the continuous addition method includes the power feed type.

18. The method of claim 3, wherein an initiator is further added at once, batchwise or continuously during the polymerization.

19. The method of claim 2, wherein the initiator is at least one free radical generating initiator selected from the group consisting of peroxides, azo compounds and a mixture thereof with a compound inducing oxidation-reduction thereof.

20. The method of claim 3, wherein a buffering chemical is used in the polymerization step in order to keep the pH constant.

21. The method of claim 3, wherein the polymerization temperature is 25-160 and the polymerization time is 3-24 hours.

22. The method of claim 3, wherein the proportion of the liquid material to water ranges from 60:40 to 1:99 by volume.

23. The method of claim 3, wherein the liquid material remains in the liquid state at a temperature of 10-100° C. and a pressure of 1-20 atm.

24. The method of claim 3, wherein the sum of the water solubility of the ingredients which composed of the liquid material at room temperature is lower than 7.5 g per 100 g of water.

25. The method of claim 2, wherein the liquid particle is dispersed in water, has a diameter ranging from 50 nm to 1500 nm and the diameter does not increase by 20% or more when kept at room temperature for a day.

26. The method of claim 3, wherein the liquid particle is dispersed in water, has a diameter ranging from 50 nm to 1500 nm and the diameter does not increase by 20% or more when kept at room temperature for a day.

27. The method of claim 3, wherein the water solubility of the hydrophobe is lower than or equal to 5×10⁻⁶ g/kg at 25° C.

28. The method of claim 3, wherein the hydrophobe is at least one selected from the group consisting of C₁₂-C₂₀ aliphatic and aromatic hydrocarbon derivatives, C₁₂-C₂₀ aliphatic alcohols, acrylate having a C₁₂-C₂₀ alkyl groups, C₁₂-C₂₀ alkyl mercaptan derivatives, organic dyes, fluorinated alkanes, silicone oil compounds, natural and synthetic oils, and oligomers and polymers having a molecular weight of 1,000-500,000.

29. The method of claim 3, wherein the emulsifier is at least one selected from the group consisting of an anionic emulsifier, a cationic emulsifier and a non-ionic emulsifier.

30. The method of claim 18, wherein the initiator is at least one free radical generating initiator selected from the group consisting of peroxides, azo compounds and a mixture thereof with a compound inducing oxidation-reduction thereof.
